(19) United States
(12) Patent Application Publication
(10) Pub. No.: US 2025/0050766 A1
(43) Pub. Date: Feb. 13, 2025

(54) ELECTRIC CHARGING HOLSTER WITH LATCHING MECHANISM

(71) Applicant: SPEED CHARGE, LLC, Carter Lake, IA (US)

(72) Inventors: Christopher William Ledesma, San Francisco, CA (US); Seigo Ma, Oakland, CA (US)

(21) Appl. No.: 18/231,146

(22) Filed: Aug. 7, 2023

(51) Int. Cl. B60L 53/30; H02J 7/00

(52) U.S. Cl. CPC B60L 53/30; H02J 7/0042; B60L 53/16

(57) ABSTRACT

A holster for an electric vehicle charging station is provided with a locking mechanism to selectively secure a charging gun within the holster. The locking mechanism includes a locking finger that is selectively received in an aperture of a docking collar of the charging gun. A release lever or handle of the locking mechanism is biased toward a non-released position. The biasing member may be in the form of a spring. Alternatively, the biasing member may take the form of a magnet.

### FIELD

This disclosure relates generally to electric charging stations and, more specifically, to holsters for electric vehicle charging stations, the holsters provided with a latching mechanism to releasably secure an electric vehicle charging gun within the holster.

### BACKGROUND

Not all charging guns (for electric vehicles and the like) include integral locks to secure the charging plug in the holster of an associated charging station, such as an electric vehicle charging station. For charging guns that lack a latch or other lock to secure the charging gun to a holster, there is increased risk of the charging gun falling out of the holster, or losing a firm engagement with the holster, causing user inconvenience and potentially compromising the ability of the electric charging station to recognize the charging gun is within the holster and take appropriate action such as communicating signals that the charging gun is available for use, and/or upon disengagement of the charging gun from the holster, signal a graphical user interface of the charging station to initiate a set of prompts, an audio and/or video message, or alert a local or remote monitoring station that the particular charging gun has been disengaged from the holster. Accurate data as to the number, and frequency, of disengagements of particular charging guns from their respective holsters can be collected to inform maintenance schedules, inform decisions as to power distribution among a plurality of charging stations, indicate the level of demand to inform decisions as to installation of additional charging stations, or to track user-preferred locations among a plurality of closely-situated charging stations to inform decisions as to recommended layouts of new electric charging station centers.

### SUMMARY

A releasable locking mechanism for selectively securing an electric vehicle charging gun to a holster. The locking mechanism includes a locking finger or tang received in a complementary aperture provided in a docking collar of the charging gun. The releasable locking mechanism is holster-mounted and includes a release handle to disengage the locking finger or tang from the aperture in the docking collar of the charging gun. The locking mechanism includes a biasing member, such as a spring, to bias the release handle into an unreleased position, such that the locking finger or tang remains in locking engagement with the aperture of the docking collar of the charging gun.

### BRIEF DESCRIPTION OF THE DRAWINGS

FIG. 1 is a perspective view of a charging gun securely received in a holster of an electric vehicle charging station, provided with a locking mechanism of a first embodiment of the present disclosure;

FIG. 2 is a front elevation view of the charging gun and holster of FIG. 1;

FIG. 3 is a perspective view of the holster of an electric vehicle charging station of FIG. 1;

FIG. 4 is a cross-sectional view of the charging gun and holster of FIG. 1, taken along lines 4-4 of FIG. 2;

FIG. 5 is a front, bottom, right perspective view of a locking finger and release handle of the holster of the first embodiment of the present disclosure;

FIG. 6 is an exploded front, top, right perspective view of a charging gun and the locking finger and release handle of FIG. 1;

FIG. 7 is an exploded rear, top, right perspective view of a charging gun and the locking finger and release handle of FIG. 1;

FIG. 8 is a rear, top, perspective view of the locking finger and release handle of FIG. 1, in combination with a coil spring secured to the locking finger and a rod member, which coil spring biases the locking finger in a locking condition;

FIG. 9 is a cross-sectional view taken along lines 9-9 of FIG. 2;

FIG. 10 is a locking finger and front, left perspective view of a holster with locking mechanism of an alternate embodiment, with a charging gun lockingly received in the holster;

FIG. 11 is a front perspective view of the holster of FIG. 10;

FIG. 12 is a rear, left, top perspective view of a locking mechanism of the holster of FIG. 10 and associated magnet;

FIG. 13 is a front, right, bottom perspective view of a locking mechanism of the holster of FIG. 10 and associated magnet;

FIG. 14 is a cross-sectional view taken along lines 14-14 of FIG. 10; and

FIG. 15 is a perspective view of a portion of a docking collar of a charging gun and a locking mechanism of the holster of FIG. 10.

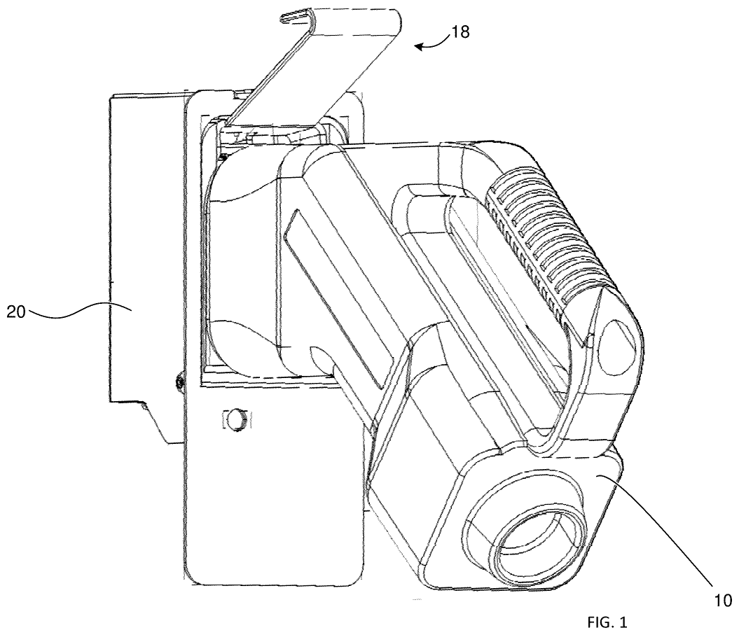

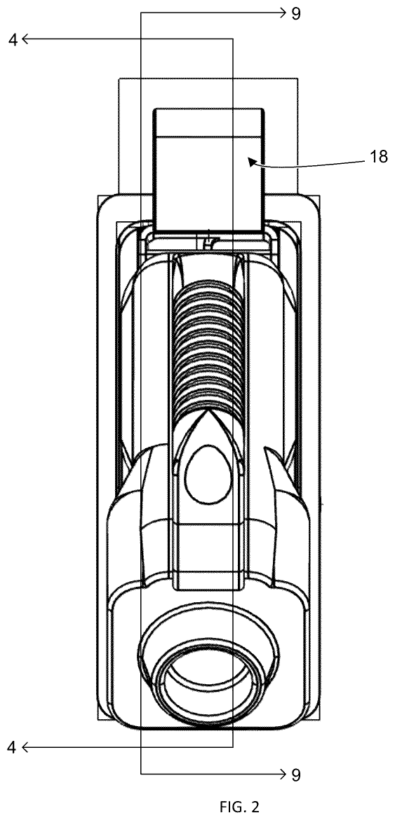

### DETAILED DESCRIPTION OF THE PREFERRED EMBODIMENTS

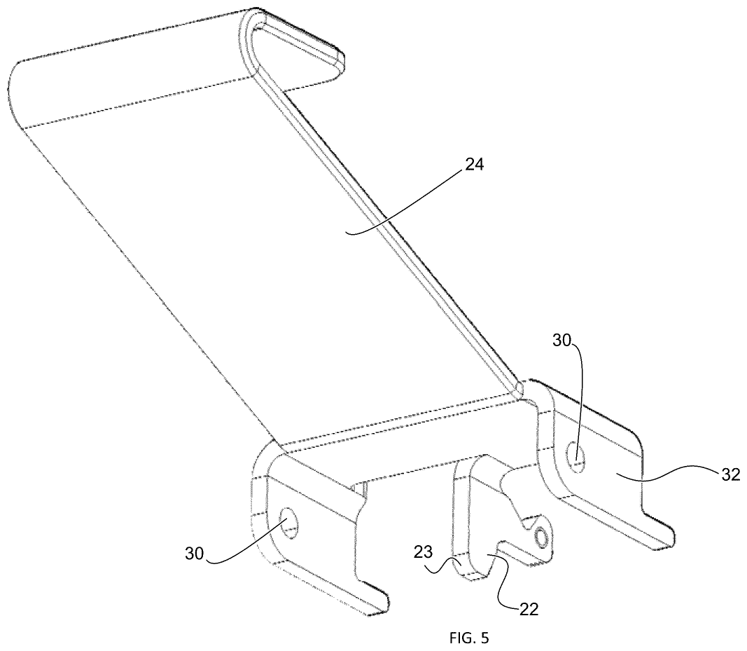

With reference to the several views of the drawing, a charging gun 10 for an electric vehicle (not shown) is selectively received in a holster 20 of an electric vehicle charging station. The holster 20 includes a locking mechanism 18 to secure the charging gun 10 in the holster 20. In one embodiment, as best illustrated in FIG. 5, the locking mechanism includes a locking finger 22 that is formed as an integral extension of a release lever, also referred to herein as a release handle 24.

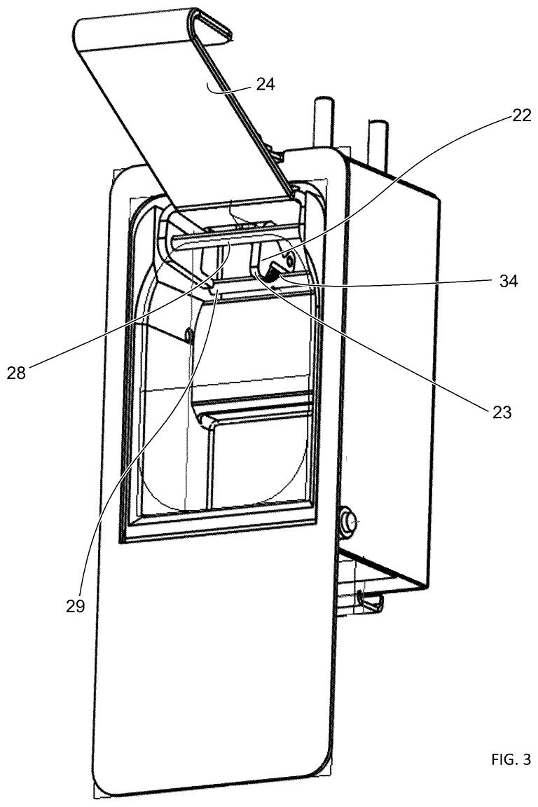

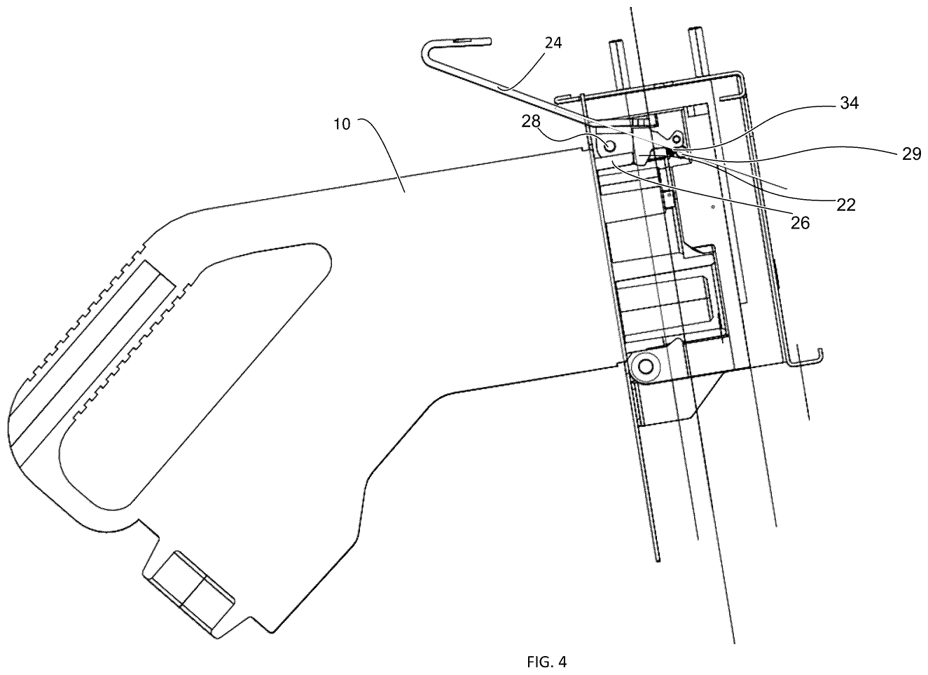

The locking finger 22 is received in an aperture 26a of a docking collar 26 of the charging gun 10. In one embodiment, pulling on the release handle 24 causes the locking mechanism to pivot about a rod 28 within the holster 20, as illustrated in FIGS. 3 and 4, which rod 28 passes through pivot rod-receiving apertures 30 in engagement arms 32 of the release handle 24. A spring 34 is secured to a second rod, which serves as a stop rod 29, and to the locking mechanism 18. The spring 34 serves to bias the locking finger 22 into its position of locked engagement with the aperture 26a of the docking collar 26 of the charging gun 10, while also biasing the release handle 24 toward its raised, non-released position.

A charging gun 10, with a cable (not shown), can collectively weigh approximately 10-20 pounds. Removing a charging gun 10 from a holster 20 can require both hands of the user, so it is preferable that the locking finger 22 be easily removable from the aperture 26a of the docking collar 26 with minimal force applied to the release handle 24 by the user. In selecting a stiffness of the spring 34, it is desirable to select a stiffness that provides a sufficient biasing force to push the release handle 24 into its raised, non-released position when the charging gun 10 is in the holster, and even if the user lets go of the charging gun 10 when the docking collar 26 is only partially inserted in the holster 20, so long as at least a portion of the locking finger 22 is in the aperture 26a of the docking collar 26, the biasing force applied by the spring 34, in cooperation with a curvature of the locking finger 22 that tends to direct the locking finger 22 into the aperture 26a, achieves a mechanical semi-automatic locking engagement. However, the spring 34 should not be so stiff as to require the user to apply more than just a few pounds of force to the release handle 24 to overcome the biasing force and disengage the locking finger 22 from the aperture 26a of the docking collar 26. The stiffness of the spring 34 and geometry of the release handle 24 are preferably selected such that the release handle 24 can be manipulated from its raised, non-released position to its lower, released position with just a push by the user's thumb, finger, forearm, elbow, or the like.

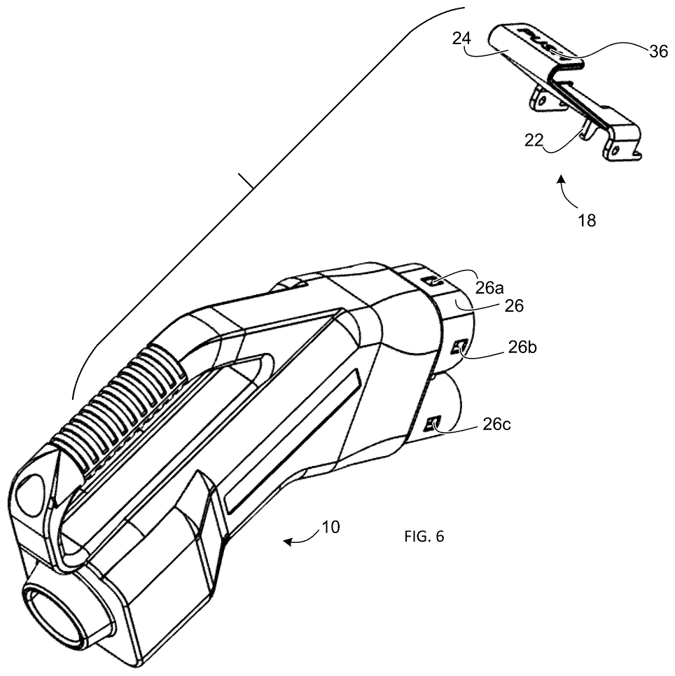

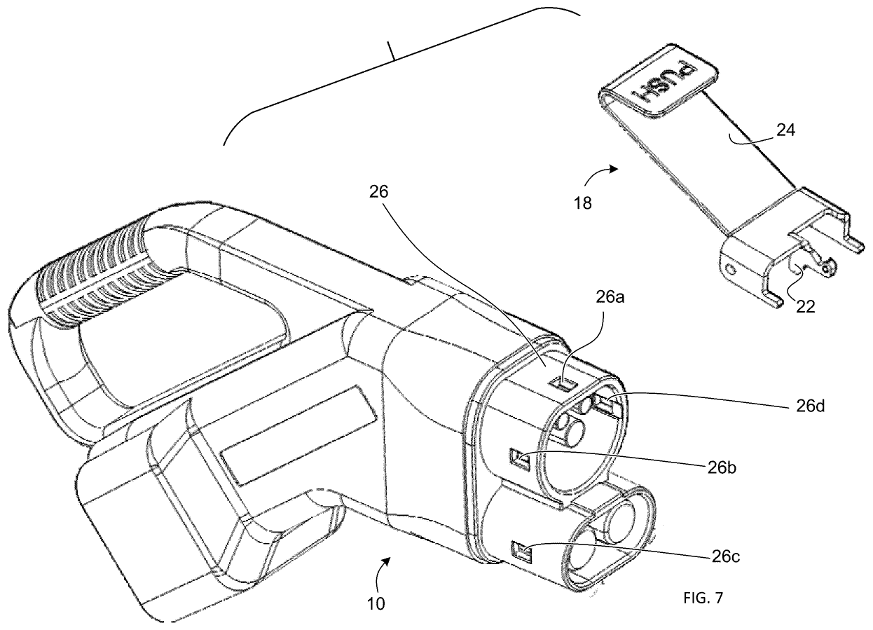

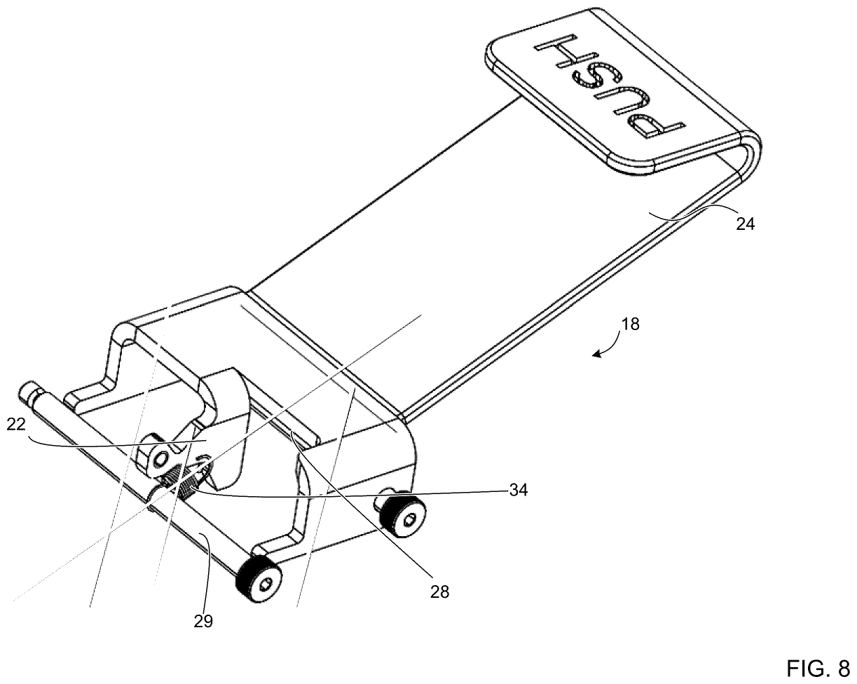

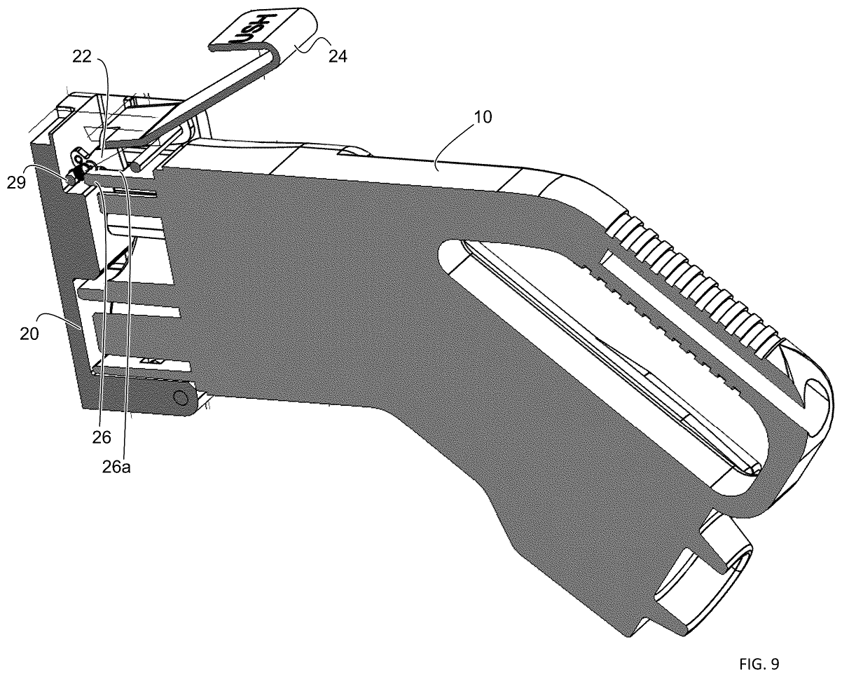

To facilitate the mechanical semi-automatic locking engagement of the locking finger 22 into the aperture 26a, the lower front corner 23 of the locking finger 22 is radiused, although it could alternatively, or additionally, be inclined or sloped. As can be appreciated from FIGS. 6 and 7, in addition to aperture 26a, the docking collar 26 can include multiple apertures, such as rectangular apertures 26b, 26c, and 26d. While the locking mechanism 18 is configured in the holster 20 so as to selectively engage the aperture 26a on the top wall of the docking collar 26, it would be within the scope of the present disclosure to orient a locking mechanism in a holster 20 such that one or more locking fingers of the locking mechanism instead selectively engage one or more apertures 26b, 26c, and 26d along a different wall of the docking collar 26. If desired, the release handle 24 may be provided with indicia 36, such as the word “PUSH”, or an arrow pointing in the direction of a charging gun 10 received in the holster 20, to aid a user in understanding how to manipulate the release handle 24 to disengage the charging gun 10 from the holster 20. The indicia may be printed on, etched in, or cut entirely through a tab portion of the release handle 24.

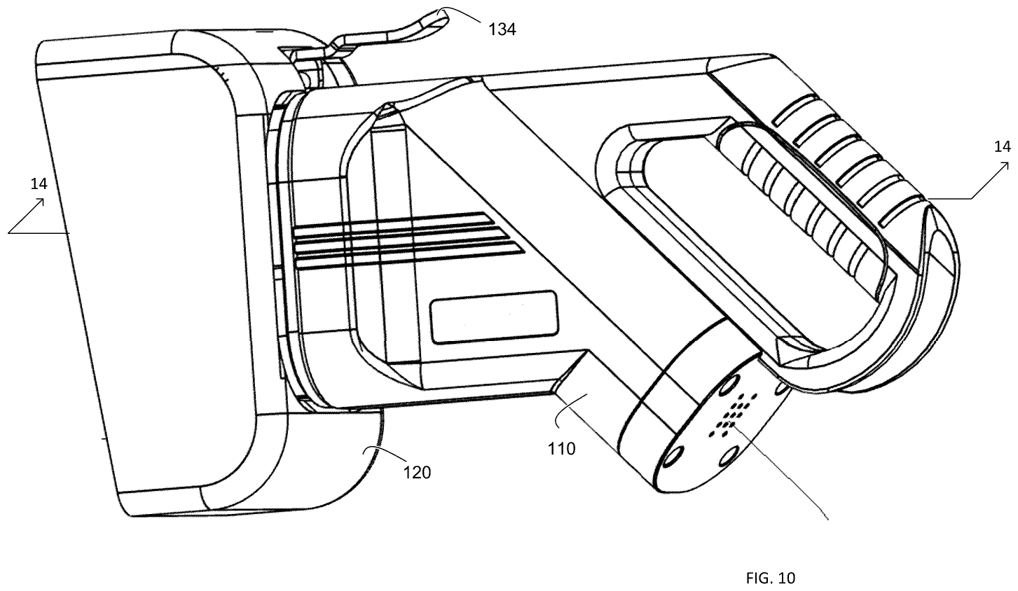

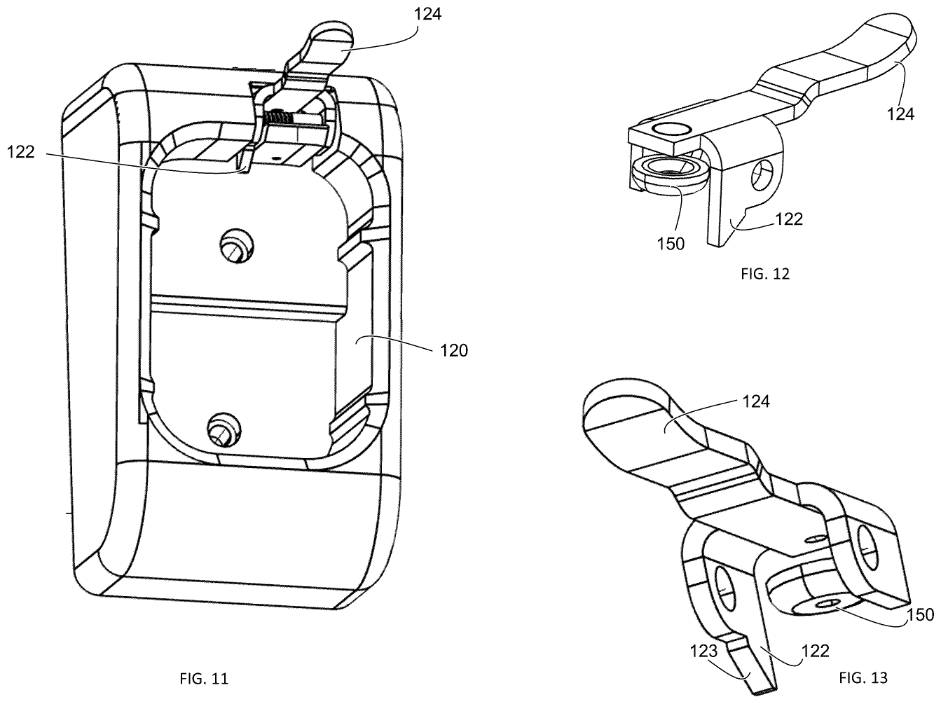

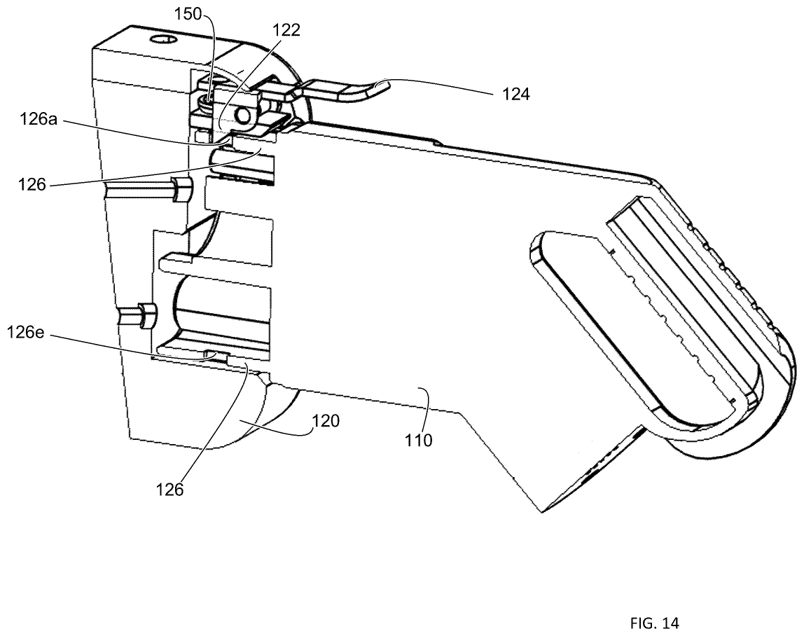

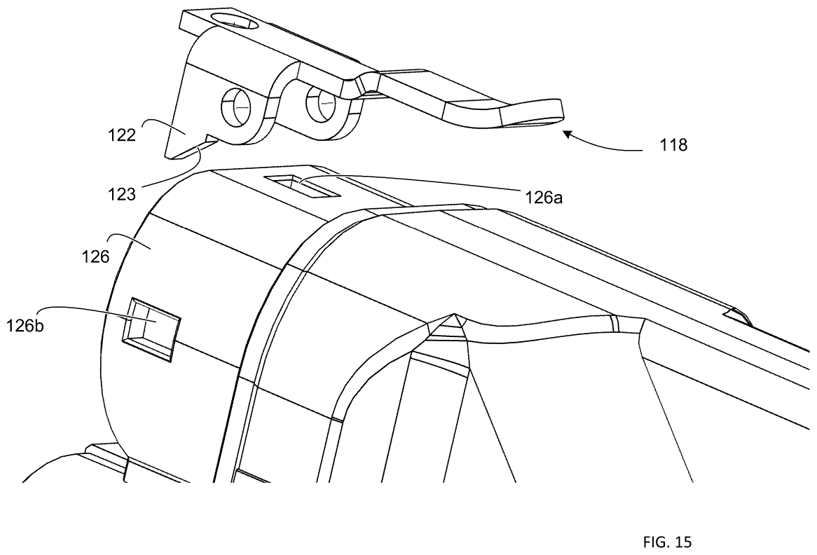

Referring to FIGS. 10-15, in an alternate embodiment, where all corresponding elements are referenced by similar reference numbers to those of the above-described embodiment, increased by 100, a locking finger 122 is formed integrally with a release lever 124. Rather than a spring, a magnet 150 is provided on the holster 120 in a position below a rearwardly-extending ledge 152 of the locking mechanism 118. The magnet 150 is tunable, in that it can be selected to have a strength that, when factoring in the nominal distance of the magnet 150 from the rearwardly-extending ledge 152 when the release lever 124 is in its raised, non-released position, affords sufficient biasing force to urge the release lever 124 to maintain its raised, non-released position and keep the locking finger 122 engaged with the aperture 126a of the docking collar 126 of an associated charging gun 110, yet still permit the release handle 134 to be depressed with a modest amount of force by a user's thumb, finger, elbow, forearm, or the like, to disengage the locking finger 122 from the aperture 126a of the docking collar 126 in order to release the charging gun 110 from the holster 120.

As in the above-described embodiment, the locking finger 122 may be provided with a geometry that facilitates insertion of the docking collar 126, such as providing a lower front corner 123 with an incline or slope, which promotes ease of insertion of the docking collar 126 to a position in which a portion of the docking collar distal to the aperture 126a (or whichever aperture of the docking collar is to receive the locking finger 122) passes the locking finger 122 so the locking finger 122 will enter the aperture 126a. As with the previous embodiment, apertures 126b, 126e may be included in different walls the docking collar 126 than the top wall, and a locking mechanism of the present disclosure could be configured in such a way that its locking finger selectively engages one of these other apertures such as aperture 126b or 126e.

While various embodiments have been described herein, it will be understood that variations can be made thereto that are still within the scope of the appended claims.

What is claimed is:

1. A holster for an electric charging station, comprising:
a recess that accommodates a docking collar of a charging gun to be received in the holster, the docking collar having an aperture therethrough;
a locking mechanism having a release lever and an associated locking finger selectively received in the aperture in the docking collar; and
a biasing member to bias the release lever toward a non-released position.

2. The holster of claim 1, wherein the locking finger of the locking mechanism includes a leading edge that is shaped to facilitate movement of the locking finger, relative to the docking collar, along a portion of the docking collar distal of the aperture when inserting the docking collar into the holster.

3. The holster of claim 2, wherein the leading edge of the locking finger is radiused.

4. The holster of claim 2, wherein the leading edge of the locking finger is inclined.

5. The holster of claim 1, wherein the biasing member is a spring.

6. The holster of claim 5, further comprising a support rod about which the locking mechanism is pivotable.

7. The holster of claim 6, further comprising a second rod that serves as a stop to limit rotation of the locking mechanism.

8. The holster of claim 6, wherein the spring is secured to the second stop and to the locking finger.

9. The holster of claim 1, wherein the biasing member is a magnet.
